(19) United States
(12) Patent Application Publication
(10) Pub. No.: US 2024/0220889 A1
(43) Pub. Date: Jul. 4, 2024

(54) PAIR PROGRAMMING PAYOFF WITH PROJECT OBJECTIVE

(71) Applicant: International Business Machines Corporation, Armonk, NY (US)

(72) Inventors: Pranshu Tiwari, Delhi (IN); Swarnalata Patel, Morrisville, NC (US); Saurabh Trehan, Gurgaon (IN); Harish Bharti, Pune (IN)

(21) Appl. No.: 18/090,963

(22) Filed: Dec. 29, 2022

(51) Int. Cl. G06Q 10/0631; G06F 18/23213

(52) U.S. Cl. CPC G06Q 10/06313; G06F 18/23213

(57) ABSTRACT

An end-to-end framework that provides for pair programming can determine a project intent. Programming requirements needed to fulfill the project intent can be identified. The programming requirements can be reduced into lower dimensions. The reduced programming requirements can be clustered into clusters. A common theme can be identified in each of the clusters. From at least one of the clusters having a common theme corresponding to the programming requirements, feasible pairs of developers can be selected. At least one optimal pair of developers can be determined among the feasible pairs using an optimization algorithm that optimizes the project intent.

### BACKGROUND

The present application relates generally to computers and computer applications, and more particularly to an end-to-end framework for pair programming, which can leverage machine learning.

Pair programming is a strategic direction for an organization to implement quality at early stage of software development lifecycle and reap the benefit with the top-quality end product. Currently, there is minimal method or solution available which identify right pair of programmers for pair programming that complement each other in strength and weakness based on the organization intent of code quality, knowledge sharing, and others.

### BRIEF SUMMARY

The summary of the disclosure is given to aid understanding of a computer system and method of providing an end-to-end framework for pair programming, and not with an intent to limit the disclosure or the invention. It should be understood that various aspects and features of the disclosure may advantageously be used separately in some instances, or in combination with other aspects and features of the disclosure in other instances. Accordingly, variations and modifications may be made to the computer system and/or their method of operation to achieve different effects.

A computer-implemented method, in an aspect, can include determining a project intent. The method can also include identifying programming requirements needed to fulfill the project intent. The method can further include reducing the programming requirements into lower dimensions. The method can also include clustering the reduced programming requirements into clusters. The method can also include identifying a common theme in each of the clusters. The method can further include selecting from at least one of the clusters having a common theme corresponding to the programming requirements, feasible pairs of developers. The method can also include identifying at least one optimal pair of developers among the feasible pairs using an optimization algorithm that optimizes the project intent.

A system, in an aspect, can include at least one processor. The system can also include at least one memory device coupled to at least one processor. At least one processor can be configured to determine project intent. At least one processor can also be configured to identify programming requirements needed to fulfill the project intent. At least one processor can also be configured to reduce the programming requirements into lower dimensions. At least one processor can also be configured to cluster the reduced programming requirements into clusters. At least one processor can also be configured to identify a common theme in each of the clusters. At least one processor can also be configured to select from at least one of the clusters having a common theme corresponding to the programming requirements, feasible pairs of developers. At least one processor can also be configured to identify at least one optimal pair of developers among the feasible pairs using an optimization algorithm that optimizes the project intent.

A computer readable storage medium storing a program of instructions executable by a machine to perform one or more methods described herein also may be provided.

Further features as well as the structure and operation of various embodiments are described in detail below with reference to the accompanying drawings. In the drawings, like reference numbers indicate identical or functionally similar elements.

### BRIEF DESCRIPTION OF THE DRAWINGS

FIG. 1 illustrates a computing environment in an embodiment.

FIG. 2 is a flow diagram showing a method of pair programming in an embodiment.

FIG. 3 is a diagram illustrating examples of clusters derived from clustering in an embodiment.

FIG. 4 is a diagram illustrating an example of a graph created for generating an adjacency matrix for pair programming in an embodiment.

FIG. 5 is a diagram illustrating system architecture for pair programming in an embodiment.

### DETAILED DESCRIPTION

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as pair programming algorithm code 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI), device set 123, storage 124, and Internet of Things (IOT) sensor set 125), and network module 115. Remote server 104 includes remote database 130. Public cloud 105 includes gateway 140, cloud orchestration module 141, host physical machine set 142, virtual machine set 143, and container set 144.

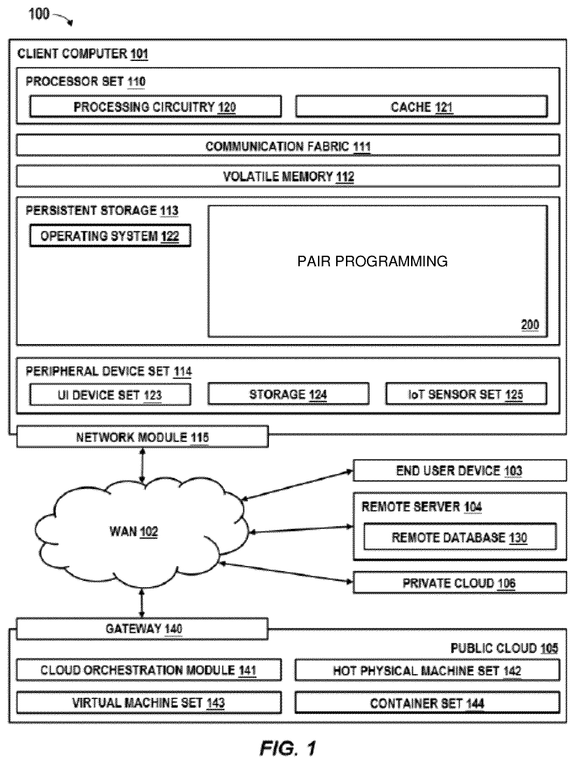

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

An end-to-end framework, in one or more embodiments, takes into consideration multiple parameters enhanced by mathematical algorithms and provides recommendation policy to identify pairs of programmers in the team based on the project objective. In an embodiment, the end-to-end framework can be systematic, and need not be ad hoc.

A system and/or method which can provide an end-to-end framework can take into consideration a requestor's such as a client's need, organization intent and also multiple parameters of the programmers such as, but not limited to, technology skill, number of years of experience, qualification, institute, project type worked on, and/or others. The system and/or method can consider the cost of the pair programmers, the proximity index of the programmers based on the number of projects they have worked together. The system and/or method can also provide a list of feasible pair programmers and then optimize the list of pair programmers. Based on the project type, e.g., of simple or complex, the system and/or method can use different mathematical models to determine the optimal pair programmers.

The system and/or method can customize pair programming to project intent, for example, which may depend on complexity of pair programming requirements; The system and/or method can provide developer skill matrix matching feasibility pairing using techniques such as, but not limited to, principal component analysis and/or clustering/gaussian mixture model. Pair programming technique in an embodiment is based on functional skills and past work experience. The system and/or method can perform optimized pairings among feasible pairings to reduce cost of requestor, using pairing based integer programming. In an aspect, cosine similarity technique can be used to recommend pairing.

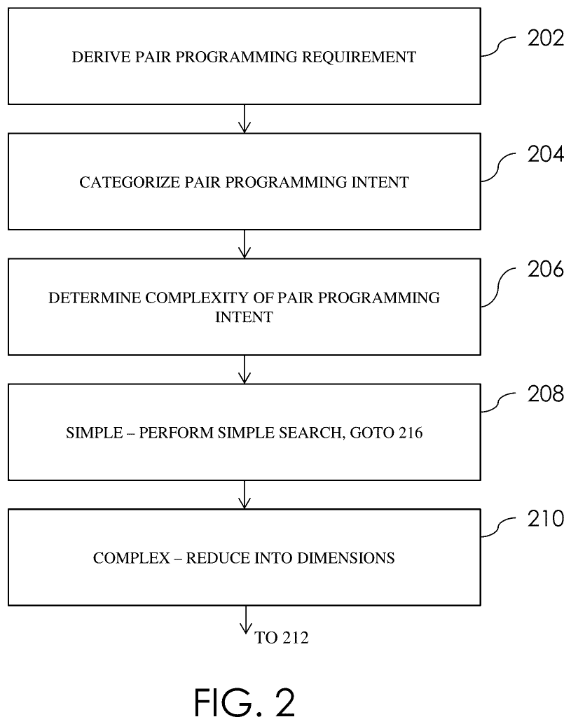

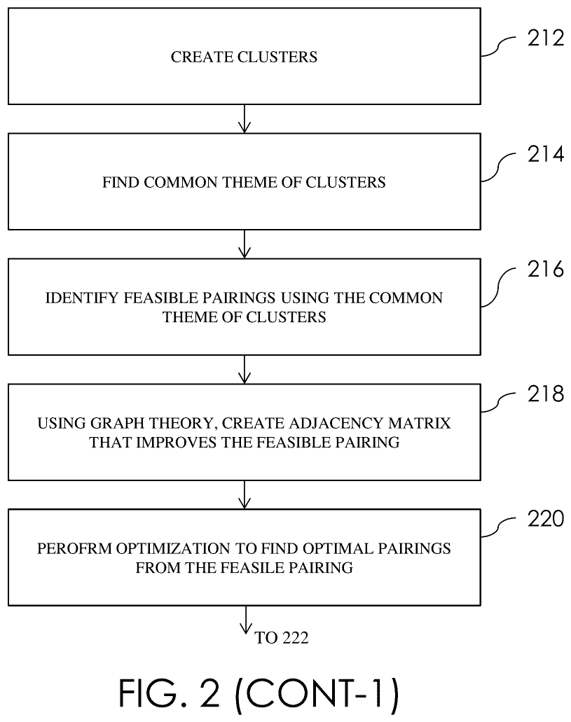

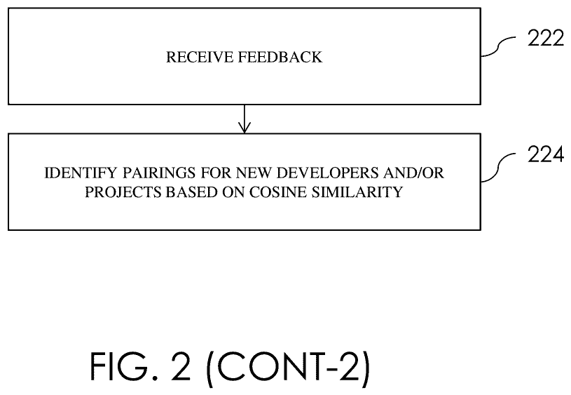

FIG. 2 is a flow diagram illustrating a method in an embodiment. The method can be performed by one or more hardware processors, for example, in an environment described above with respect to FIG. 1. At 202, the method can include defining and understanding project objective which derives pair programming requirement. At 204, based on the programming requirement, the method can categorize the complexity of pair programming intent. A project objective can be a set of requirements. Intent can drive the project objective. Each project objective can lead to a set of requirements. If an intent is to have a full stack of developers by the end of a project, an objective associated with that intent can be to keep mix and match of multi-developed skills.

At 206, the method can take pair programming intent, for example, from the project objective and/or pair programming requirement, which can decide the complexity. The processing of 202, 204 and 206 can determine a project intent and identify pair programming requirement, e.g., various attributes required or needed to fulfill the project intent. Attributes can be various characteristics associated with developers (or e.g., programmers, engineers, etc.). By way of example, complexity can be determined based on number of attributes required for fulfilling or meeting the project intent. For example, given a threshold number, if the number of attributes required for fulfilling the project intent is greater than or equal to the threshold number, the project intent can be considered “complex”; similarly, if the number of attributes required for fulfilling the project intent is less than the threshold number, the project intent can be considered “simple”. Other criterion or criteria can be used to determine complexity.

At 208, in case of simple intent, the method can use binary search/hash table/TRIE (a k-ary search tree, or tree data structure used for storing and searching a specific key from within a set) to find the closed feasible pairing of developers by filtering the data and finding appropriate resources. The method can then proceed to 216, where the method identifies feasible pairings of developers. (e.g., or programmers, engineers, etc.).

At 210, in case of intent that is “complex”, where a requestor may request to look into various aspects involving various attributes, the method can reduce requestor's requirements into relevant dimensions, e.g., into lower dimensions, by creating Eigen vectors through linear and non-linear techniques. In an aspect, reducing the dimensionality or dimension of the requirements can increase or transform the density of data, making it easier to cluster that data. The method can use single vector decomposition and t-distributed stochastic neighbor embedding (t-SNE) to create Eigen vector for faster performance.

At 212, the method can create clusters in Eigen vector space and identify clusters on linear and non-linear dimension reduction. In this case, the method can use Gaussian mixture model and K-clustering techniques to determine or identify clusters. Here, clusters of developers having certain attributes can be created. For example, developers can be clustered based on the developers' skill attributes.

At 214, the method can find clusters and common themes for feasible pairings. Each cluster can have a plurality of characteristics or programming requirements, for example, attributes. Based on such programming requirements in a cluster, a common theme can be determined. For example, if there are n clusters, cluster 1 may have characteristics A, B, and C among other characteristics, which would be considered a common theme for that cluster; cluster 2 may have characteristics B and D, which would be considered a common theme for that cluster; cluster 3 may have characteristic E among other characteristics, which would be considered a common theme for that cluster; and so forth, to cluster n. For example, based on technology identification, the method can identify developer characteristics, which can include overall experience, qualification, and number of experience in that technology.

At 216, the method can identify feasible pairings of two developers, for example, taking into consideration requestor need, organization intent, attributes of the programmers. Feasible pairings can be selected from at least one of the clusters having a common theme that corresponds to the programming requirements. At 218, the method can create an adjacency matrix using graph theory to further improve feasible pairing by considering past project experience.

At 220, the method can find optimal pairings among feasible pairings, for example, which minimize cost. Cost can be in terms of time duration of the project, technical resources needed for the project, and/or others.

At 222, the method can receive feedback from the requestor. If the requestor does not agree with the provided one or more pairings, the method can repeat by proceeding to 106.

At 224, for new developers or requestors, the method can use cosine similarity to identify which developers could fall in which category. This would bypass having to repeat or re-run processes of 204-222 described above.

The method can customize pair programming based on a specified project intent. For example, given a project intent of training a new developer to work on an existing project, the method may pair a highly skilled subject matter expert (SME) with a newly joined developer, for example, for the SME in a driver role and the newly joined developer or novice in an observer role. In this example, the method may, for all the listed parameters or attributes (e.g., specific skill, qualification, institute, project type, experience year), identify the SME and novice. The method may find developers at the higher end of scale and lower end of scale, pair those programmers and create clusters.

As a second example, given a project intent that is to promote improvement in development and operations (DevOps) where development and operations teams work together across software application life cycle, e.g., from development and test through deployment to operations, the method may pair a developer with a release management programmer. In this second example, the method may identify the programmer with specific development skill based on the parameters (e.g., specific skill, qualification, institute, project type, experience year) and identify the programmer with release management programmer skill. The scale can be any level of development skill and medium to high level of release management skill. The method may pair them together and create clusters.

As a third example, given a project intent that is to promote improvement in test driven development, the method may pair the developer with the tester. In this third example, the method may identify a programmer with a specific development skill, identify a programmer with a specific testing skill, pair them together and create clusters.

As a fourth example, given a project intent that is to improve an environment of full stack developer, the method may pair frontend developer with backend developer. In this fourth example, the method may identify the programmer with frontend development skill, identify the programmer with backend development skill, pair them together and create clusters. As a fifth example, given a project intent that is to fill-in a position or responsibility of an outgoing developer, the method may pair the outgoing developer with the incoming developer, e.g., expert-expert, novice-novice).

As a sixth example, given a project intent that is to improve code quality, the method may pair developers of same technology, same coding proficiency level who can switch the role of “driver” and “observer”. The code review can occur instantly, and the code quality can be improved. Achieving a better code quality or improvement in code quality an reduce cost of fixing defects in the long run. In the sixth example, the method may, for all the listed parameters (e.g., specific skill, qualification, institute, project type, experience years), rate the developers based on scale, and identify the SME and novice. The method may identify developers at the same level of scale, pair those programmers (e.g., expert-expert, novice-novice), and create clusters.

As a seventh example, given a project intent that is to develop interpersonal skill among project team members, the method may pair more experienced developer with relatively new developer (e.g., experienced in the project-new in the project). In the seventh example, the method may, for all the listed parameters (e.g., specific skill(s), qualification(s), institute(s), project type(s), experience year(s)), identify the SME and novice, choose developers at the higher end of scale and lower end of scale, pair those programmers and create clusters.

As an eighth example, given a project intent that is to promote knowledge sharing, the method may pair developers from cross cutting technologies, e.g., one developer from Microservice and another from database. In this eighth example, the method may, for all the listed parameters (e.g., different technology skill for each programmer, qualification, institute, project type, experience year), identify the SME of one skill and novice of another skill, pair those programmers and create clusters.

As a ninth example, given a project intent that is to backup an existing team of developers, e.g., for supporting a multi-year or long duration project, the method may pair the developer with the same skill and similar proficiency level who can become the backup of the other in case the need arises (e.g., expert-expert, novice-novice).

Examples of project intent and pairing based on the project intent can abound and are not limited to those described above. The method in one or more embodiment can analyze or identify a project intent and provide an end-to-end framework of providing a customized pair programming solution, e.g., based on a specific project intent, requirements and attributes.

Referring to 202, where the method defines and identifies project objective which drives pair programming requirement, the requirement of the programmers can vary for each requestor based on the project type. The project type can be green field development, research, application maintenance and support, custom framework development, package/tool enhancement, automation testing, release management, and/or others. The proficiency level of the programmers needed for these project types can vary to a significant level. For instance, the research and green field development project may need programmers having depth of technical concepts, programming patterns, knowledge and high level of proficiency in logical reasoning ability, syntax of the language, script and should be able to perform technical proof of concepts, setting up the environment for programming from scratch. This level of proficiency might not be needed for application maintenance and support, automation testing type of projects. At 202, such differences can be identified, and at 204, based on identified requirements, complexity of pair programming intent can be categorized.

Referring to 206, project category defines client intent and type of technology required to meet client or requestor requirements, e.g., looking for R, python, Architecture coding patterns. For example, each project type can need a set of technologies. Along with the project type, the method may identify the set of technologies the project will be built upon for green field project or the set of technologies the project is already built upon for application maintenance and support kind of projects. The technologies are identified for the frontend (Hypertext Markup Language (HTML), Cascading Style Sheets (CSS), React.JS, JavaScript, etc.), backend (Java, C. C++, etc.), databases (e.g., relational database management system (RDBMS), etc.), middleware, custom/client specific frameworks, Extract-Transform-Load, Build Utilities, messaging system, Tools on static and dynamic code review, Unit testing patterns and code.

Referring to 210, for example, consider that X is (m×n) subspace ϵR\hat{ }n where n represents n dimensions and m represents the number of deployments/projects. The skills can be considered the driving factor to determine strength and weakness of developers and can be used as input for recommendation framework that can help in performing pairing. For example, one developer who is good or has high rating score in ETL but has weakness in middleware skills can be paired with another developer who is good in middleware and weak in ETL. In this way pairing may help to achieve the desired outcome.

Principal component analysis (PCA) is a technique for reducing the dimensionality of such datasets, increasing interpretability but at the same time minimizing information loss. Principal component analysis can be arrived through singular vector decomposition if the initial matrix is normalized. The matrix X has discrete and categorical numbers which can be normalized by creating a multivariate project development database(s). In this case, the method can use single vector decomposition to create PCA with less complexity. This can be created by computing covariance of X and is called S.

$$S = ( X - \overline{X} ) {( X - \overline{X} )}^{T} \qquad eq ( 1 )$$

$$M = U * \sum * {V}^{T}$$

where S=M^{T}M where M is normalized version of X,
and X is n*m dimensions where X represents matrix of m developers with n attributes,
U, V are n×r and p×r matrices with orthonormal columns (U′U=Ir=V′V, with Ir the r×r identity matrix) and Σ is an r×r diagonal matrix. The columns of V are called the right singular vectors of S or M^{T}M. The columns of U are called the left singular vectors of S and are the eigenvectors of the n×n matrix M^{T}M′ that correspond to its non-zero eigenvalues. The diagonal elements of matrix are called the singular values of S and are the non-negative square roots of the (common) non-zero eigenvalues of both matrix M^{T}M and matrix M^{T}M. The method can tune the number of principal components to preserve the information as per equation: λᵢ=Σᵢᵢ².

The method can choose the largest λᵢs and select λᵢ such that they constitute 95% of information. This creates a list of eigen values and corresponding two-eigen vector create a matrix for analysis.

In case that the two principal component analysis does not carry 95% information, the method can use tSNE analysis. Two principal component vectors/Eigen vectors can be used to create clusters.

Similarly, the method can also perform t-stochastic neighborhood embedding (T-SNE). This algorithm calculates a similarity measure between pairs of instances in the high dimensional space and in the low dimensional space by calculating p(j|i) by cantering on xᵢ. This provides a set of probabilities for all points. Those probabilities are proportional to the similarities. The Gaussian distribution or circle can be manipulated using what is called perplexity, which influences the variance of the distribution (circle size) and the number of nearest neighbors. After this, the method can map the probability to Cauchy distribution and create Kullback-Leibler (KL) divergence to optimize it. p represents the probability of finding developer j given I has been found and x_i and x_j represent data attributes of i,j developers in high dimensional space,

$$p ( j \vert i ) = \frac{exp ( - {‖ {x}_{i} - {x}_{\overline{J}} ‖}^{2} / 2 {σ}_{i}^{2}}{{\sum }_{k \neq i} exp ( - {‖ {x}_{i} - {x}_{\overline{J}} ‖}^{2} / 2 {σ}_{i}^{2}} = {σ}_{i}^{2} :$$

Variance at i; j is a point other than i.

$$q ( j \vert i ) = \frac{exp ( - {‖ {y}_{i} - {y}_{\overline{J}} ‖}^{2}}{{\sum }_{k \neq i} exp ( - {‖ {y}_{i} - {y}_{\overline{J}} ‖}^{2}}$$

y_i and y_j represent attributes of developer in lower dimension,

$$Cost function = {\sum }_{i} {\sum }_{j \neq i} log ( \frac{{p}_{j \vert i}}{qj \vert i} ) \qquad eq ( 4 )$$

In an aspect, cost function represented above is sum of log ratio of probability of finding developer j given there is developer I in neighbor in high dimension(x) as compared to low dimension (y).

Referring to 212, clustering on dimensions reduction can be achieved by using K-clustering or Gaussian mixture model (GMM) to cluster the reduced dimensions.

The method may analyze the DevOps pipeline data of requestor deployments to arrive at patterns and identify clusters that are high, low or medium depth of adoption. In this case, the method can use Gaussian mixture model and K-clustering technique to arrive at clusters. For example, K-clustering uses the equation below:

### Technique 1:

$$SSE = {\sum }_{i = 1 to k = K}^{K} {\sum }_{x ∈ k}^{N} dist ( {c}_{i} , x ) \qquad Eq ( 2 )$$

K represents the clusters and SSE is the squared error loss. The method can then minimize SSE eq (2) as a loss function. To do this, the method can differentiate eq (2) to minimize the SSE loss function to arrive at the centroid value. The method thus differentiates equation 2 in an embodiment.

$$▽ SSE = \frac{\partial ssE}{\partial c} = 0 \qquad Eq ( 3 )$$

$$c = \frac{1}{m} * \sum {x}_{k} \qquad EQ ( 4 )$$

### Technique 2:

Another technique the method can use can include Gaussian mixture model. Let there be m-requestor transformation projects and among m requestor observation projects, the method can identify k patterns. Each k clusters have set of parameters and hence the method can associate k cluster with k parameter, ψ={θ₁θ₂θ₃θ₄θₖ}.

Probability of i requestor project transformation if it comes from k-th cluster with k-th parameter will be p(xᵢ|θₖ). Hence the probability of that chosen to generate an object is given by the weight (prior probability) wj.

The prior probabilities sum to one: Σωₖ=1.

Formally, there is a set of m points X={x1, . . . , xm} that are generated from some distribution p(⋅, θ), where θ denotes the unknown parameters of that distribution. Assuming that the points are generated independently, their likelihood is defined as follows.

The likelihood function of cluster belonging to the distribution is given below. Gaussian distributions assume clusters belong to various normal distributions. The likelihood function of point belonging to that distribution is given by, L(x|θ)=P(x₁x₂x₃xₘ|θ) (represents probability of pulling developer from distribution θ)

$$L ( x \vert θ ) = \prod P ( {x}_{i} \vert θ ) \qquad eq ( 5 )$$

(which is product of finding developer I, finding developer j and so on to all the developers in universe)

$$( Since P ( AB ) = P ( A ) . P ( B ) ) lOG L ( X \vert θ ) = - \frac{1}{2 {σ}^{2}} {( {x}_{n} - μ )}^{2} - m log log ( σ ) - \frac{m}{2} * log log 2 * \prod \qquad Eq ( 6 )$$

$$where μ - Mean vector of developer attributes , σ - standar deviation .$$

The method can then create a gradient vector which computes loss function as different weight vectors and arrive at best weight for which (L(θ) is minimized.

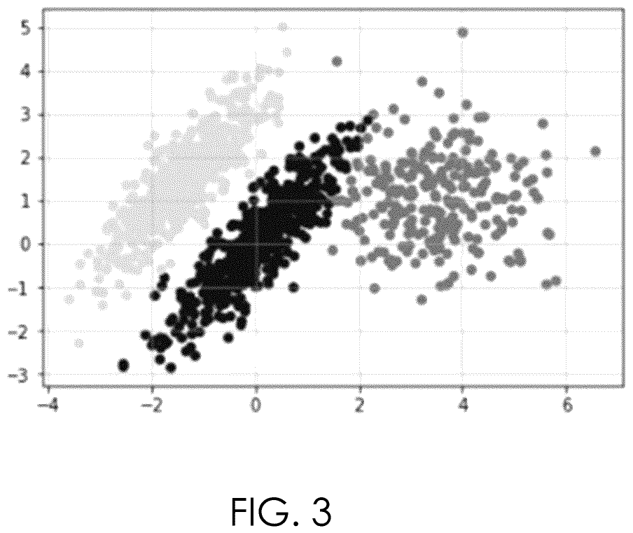

Hence, in an embodiment, clusters shown in FIG. 3 can be created by using following algorithm:
1. Select initial set of model parameters;
2. Repeat:
   Expectation step by computing p(k Distribution|Xi,ψ′)
   Maximization step as per equation 6

FIG. 3 shows an example of clustering. Clustering of skills can create themes linked to objectives.

Referring to 214, to find common themes for clusters to find feasible pairings, the method can select relevant clusters. For example, mesh-cluster matrix creation can be performed to identify patterns. Table 1 describes examples of clusters of skill characteristics where pairing can be performed for two developers. The examples show how some of the characteristics considered can be used in pairing. For instance, scores between 1-5 can represent “weak” indicator and scores between 6-10 can represent “strong” indicator.

TABLE 1

| | Capability | Capability | Capability | Capability | Capability | Capability | |
|---|---|---|---|---|---|---|---|
| Cluster | 1 (C1) | 2 (C2) | 3 (C3) | 4 (C4) | 5 (C5) | 6 (C6) | Theme |
| Cluster1 | Weak | Weak, | Strong | Weak | Weak, | Strong, | Candidates |
| | | Strong | | | Strong | Weak | C1-Weak |
| | | | | | | | C3-Strong |
| | | | | | | | C4-Weak |
| Cluster 2 | Strong | Strong | Strong | Strong | Strong | Weak | Candidates |
| | | | | | | | C1, C2, |
| | | | | | | | C3, C4: |
| | | | | | | | Strong |
| Cluster k | | | | | | | |

The method can map the “Strong” and “Weak” attributes, where “Not Aware” is associated with “Weak” and “Strong” is associated with “Expert Category”. The method can select Themes for each cluster. For example, each cluster can have a set of developers and the method can identify the themes of these developers who have similar characteristics. For instance, in the example shown in Table 1, Cluster 1 has a set of developers that have strong C3, Weak C4, Weak C3. Each programmer can be proficient with a particular set of technologies. A programmer who is proficient with a particular technology might need a learning curve for another technology. Each developer has a set of attributes. Examples of attributes can include, but not limited to, skills in technologies, number of years of experience, project type(s) the programmer has worked upon, qualification, education institute, certifications the programmer possesses, and/or others. These attributes are listed only as examples. The framework in one or more embodiments can support not only listed but also all the other attributes of the programmer.

Referring to 216 where feasible pairings are identified, the method can take into consideration requestor's need or requirement, organization intent, all the attributes of the programmers, and identify feasible pairing of the programmers.

In an embodiment, in case a mesh map cluster has any contrasting characteristics, which may get neglected in identifying key hot characteristics, the method, among n features may select bi-variate or multi-variate hot characteristics which can include following patterns.

Matrix on the developer coding pattern attributes and corresponding recommendations: Each data attribute can have vector measurement such as “Strong” and “Weak”. In an embodiment, for example, as data grows and to improve accuracy, the method can further detail these vector measurements V in scale of 1 to 5, where V∈INT, i.e., V is integer.

The recommendation can be customizable, e.g., depending on the bins and how the state is classified for each data attribute. For example,

Recommendations based on current state

| Attributes | Weak | Foundation | Expert |
|---|---|---|---|
| Skill | Low <5 | Medium 5-10 | High - above 10 |
| Functional Knowledge | Low <5 | Medium 5-10 | High - above 10 |
| Project Type | Low <5 | Medium 5-10 | High - above 10 |

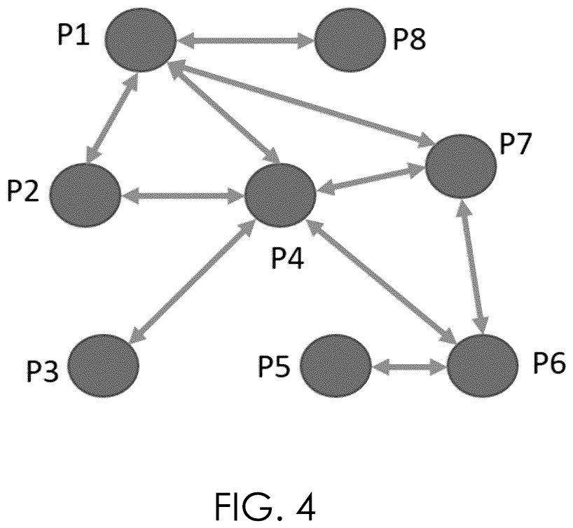

Referring to 218, the method can create an adjacency matrix to find a proximity index (closely worked pair), for example, using a technique such as Graph Theory to optimize pairings on previous work experience. FIG. 4 shows an example graph that creates an adjacency matrix in an embodiment. Consider that there are n programmers, P1, P2, P3, . . . Pn. The graph (G)∈(V, E) can be built, where V represents each node (candidate programmer) and edge represents presence of past working relationship between the candidate programmers represented by the nodes. Using such a graph, an adjacency matrix can be created. An example is shown below:

$$[ \begin{matrix}0 & 1100100 & 0 \\ ⋮ & ⋱ & ⋮ \\ 1 & 00101 ⋯0 & 1\end{matrix} ]$$

Each edge which has been marked 1 has inbuilt characteristics which is driven by past projects. For instance, programmer 1 (P1) and programmer 2 (P2) have worked on 3 projects. Similarly, programmer 2 (P2) has worked with programmer 3 (P3) on 2 projects. This relationship can be represented in the below tabular format (Table 2).

TABLE 2

| | Individual | | | | |
|---|---|---|---|---|---|
| Node | P1 | P2 | P3 | P4 | Pn |
| P1 | NA | 3 | 6 | 0 | 1 |
| P2 | 3 | NA | 1 | 2 | 1 |
| P3 | 6 | 1 | NA | 4 | 1 |
| P4 | 0 | 2 | 0 | NA | 4 |
| . . . | | | | | |
| Pn | 0 | 0 | 1 | 4 | 5 |

By way of example, proximity can be defined as shown below in Table 3.

TABLE 3

| Projects worked upon | Proximity Scale |
|---|---|
| >5 | 1 |
| 3 to 4 | 2 |
| 1 to 2 | 3 |
| 0 | NA |

By way of example, proximity index can be defined as shown below in Table 4. Table shows examples of the number of past relevant projects developers have worked together. For example, P1−P2=2 indicates that developer 1 and 2 have worked together in 2 projects. The information shown in this table can be used as a feasibility matrix.

TABLE 4

Individual

| Node | P1 | P2 | P3 | P4 |
|---|---|---|---|---|
| P1 | NA | 2 | 1 | 0 |
| P2 | 2 | NA | 2 | 2 |
| P3 | 1 | 2 | NA | 4 |
| P4 | 0 | 2 | 4 | NA |
| . . . | | | | |
| Pn | | | | |

Referring to 220, the method can optimize pairing among feasible candidates to reduce cost. For example, consider that there are N number of feasible pairings. The method using a mathematical algorithm can take the N number of feasible pairings and identify the optimal n number of pairings in order to minimize cost. For example, Let M={1, 2, 3, 4, . . . , M} represent list of candidates. Let N {0, 1, 2, 3, 4, 5, 6, 7, 8, . . . , n} represent indices in which feasible pairing are possible

$${M}_{J} ⋂ {M}_{R} = \{ \begin{matrix}0 \\ > 1\end{matrix} \} , j , k ∈ N$$

and

$${⋃}_{j = 1}^{N} {M}_{\overline{J}} = M = > All pairings possible will cover all developers .$$

Min Z=\vec{C}\vec{x}₁|AX≥b; x∈Bⁿ, b∈R^{m}, A∈m*n matrix, where A is list of constraints, C is the cost of Pairing of developers and X represents pairing vector. Each I pair is combination of two unique developers. If value of the x_i=1 this means the pair gets activated/selected, and
where,
Z is an objective function,
X is vector of m dimension variable showing 1 or 0 representing the pairing,
A is m*n matrix represents a matrix where rows represent m candidates and n presents pairings,
b represents constraint that each candidate can have more than b pairings but each pair cannot have more than 2 candidates,
C is cost of pairing which is computed by cost of individual candidate.

For example, if X=[0, 1, 0, 1, 1, 1, 0 . . . ], it indicates that the method is selecting pairing 2, Pairing 4, Pairing 5, Pairing 6. For example, each developer can have n−1 pairings, which implies that a developer can be paired with n−1 developers. However, an adjacency matrix can show (out of n−1 developers) some value less than n−1 is possible (due to a constraint that 2 developers must have worked in at least j projects). X represents possible pairings of developer 1 with other developers, e.g., ‘0’ indicates not feasible pairing, ‘1’, indicates feasible pairing. These feasible pairing can also undergo an optimization processing to selecting or activating an optimal pairing.

Augmented form matrix is shown in Table 5 below. The table shows developer pairing nodes, where the rows represent developers (1-N) and columns denote developers with whom it can be paired.

TABLE 5

| | | | | | Representative |
|---|---|---|---|---|---|
| | Pair 1 | Pair 2 | Pair 3 | Pair n | Meaning |
| Candidate 1 | 0 | 1 | 0 | 1 | Candidate 1 |
| | | | | | can be selected in |
| | | | | | Pair 2, Pair n |
| Candidate 2 | 1 | 1 | 1 | 0 | Candidate 2 |
| | | | | | can be selected in |
| | | | | | Pair 1, Pair 2, |
| | | | | | Pair 3 |
| Candidate 3 | 1 | 1 | 0 | 0 | Candidate 3 |
| | | | | | can be selected in |
| | | | | | Pair 1 and Pair 2 |
| Candidate n | | | | | |

Referring to 222, agreement can be obtained for the pair of programmers and the associated cost from a requestor (e.g., either internal or external). If the agreement is not obtained from the requestor, then steps 206 through 220 can be repeated until optimal pairs are found that are acceptable to the requestor.

Referring to 224, recommendations for new requestors or new developers for new projects with similar theme can be provided, e.g., without having to repeat the above steps, e.g., by using a cosine similarity technique. For example, consider new developers in cluster n that have qualitative measurement V:VϵINT. Then for a new requestor or new project, there can be following matrix. Let u be the projected characteristics for new requestor or new project. These characteristics can be analyzed in the initial stages of project.

$$cos θ [ similarity between developers ] = \frac{u . v [ j ]}{{‖ U ‖}_{2} {‖ v ‖}_{2}}$$

Hence if u is the new requestor and v is an existing requestor, the method can compute cosine-similarity for project1. The method can then create a vector of cosine factor and find the recommendation that is tagged to, or associated with, requestor n that has maximum similarity.

$$cos d θ = Min difference among different cos θ .$$

If, for item p in vector, cos dθ has value close to 1, then the method can choose newly recruited developers to appropriate pairings. If cos θ₁=0, it implies that the new developer can fit to the same pair to replace the existing developer.

A recommendation policy framework in one or more embodiments identifies a pair of programmers that complements each other in strength and weakness based on the organization objectives, which may include one or more of code quality, knowledge sharing, bringing the new joiners or developers up to speed, improving DevOps, improving driven development, and training developers, and/or others.

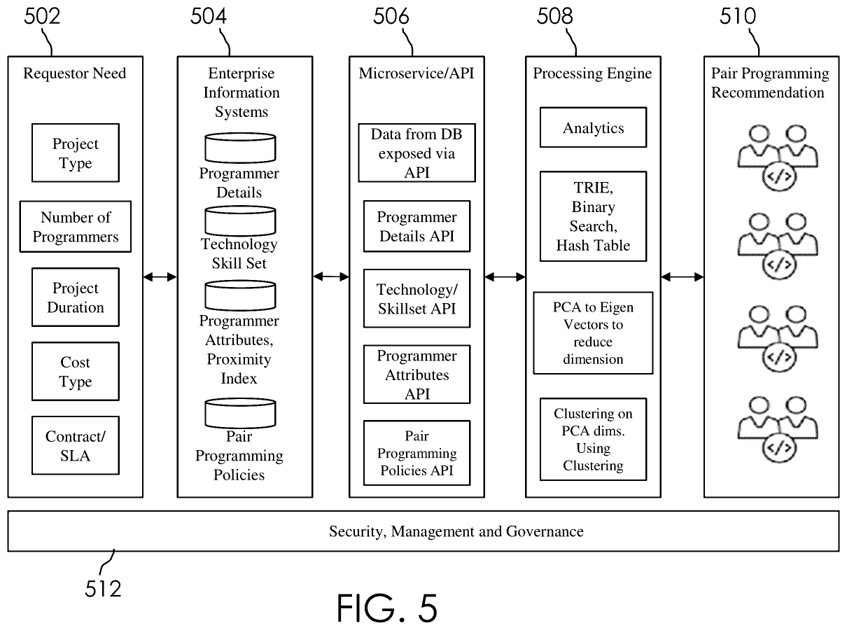

FIG. 5 is a diagram illustrating system architecture for pair programming in an embodiment. The components shown can include computer-implemented components, modules and/or functionalities, implemented on one or more processors, for example, hardware processors, for example, in a computer environment shown in FIG. 1. One or more hardware processors, for example, may include components such as programmable logic devices, microcontrollers, memory devices, and/or other hardware components, which may be configured to perform respective tasks described herein. Coupled memory devices may be configured to selectively store instructions executable by one or more hardware processors.

A requestor need 502 on the project requirement can be collected. For instance, the requestor may provide the project type for which the support is needed. The project type can be green field development, application maintenance and support, testing, release management, research, and/or others. The requestor may also provide the need on the number of programmers, the project duration, cost type (e.g., fixed price, time and cost method), contract, service line agreement (SLA) of the project, and/or other information. A module such as a user interface or another interface can be implemented to collect such data.

An enterprise information systems 504 contain data on the enterprise. For example, it 504 can contain programmer details or information, technology skill set, programmer attributes, the proximity index, pair programming policies, and/or others.

The data from the enterprise information systems is exposed via application programming interfaces (APIs). For example, microservice and/or API 506 (module or component) can contain different APIs, for example, for programmer attributes including the proximity index of the programmers, technology skill set API, and pair programming policies API, programmer information API.

A processing engine 508 utilizes the data from API and applies mathematical algorithms. Algorithms can include analytics, TRIE, binary search, hash table, PCA to Eigen Vectors to reduce dimensions, clustering on PCA dimensions, e.g., using K-clustering or GMM. Different approaches can be followed based on the complexity of the requestor's need. The programmer attributes, cost, proximity index and other factors can be taken into consideration in the mathematical algorithm. The processing engine 508 can perform processing described with reference to FIG. 2.

Recommendation 510 on optimal pair programmers can be published. Reports can be generated. The system architecture can be implemented to take into account security, management and governance 512 of the components.

A system, for example, can include one or more computer processors, implementing one or more modules or functionalities such as a pair programming mapper (which can contain requestor objectives), a skill transformer cluster mapper (which can cluster skills or technology), a recommendation engine, a feasibility pairing engine, an optimization engine, and a requestor similarity mapper. The pair programming mapper can analyze objectives and identify types of pairing, e.g., as described with reference to 202, 204, 206 in FIG. 2. The skill transformer cluster mapper can create clusters of skills, e.g., as described with reference to 212 in FIG. 2. The recommendation engine, for example, can provide, report or publish an identified pair programming (e.g., a pair of developers or programmers) (e.g., shown in 510 in FIG. 5). The feasibility pairing engine can identify feasible pairings using common theme of clusters, e.g., as described with reference to 216 in FIG. 2. The optimization engine can perform optimization to find optimal pairing from the feasible pairings, e.g., as described with reference to 220 in FIG. 2. The requestor similarity mapper can provide a recommendation for pair programming, e.g., based on cosine similarity of existing pairs, e.g., as described with reference to 224 in FIG. 2.

The method and/or system in an embodiment is an end-to-end framework, which can be performed automatically without a need for an ad hoc analysis to be performed in-between processing stages or steps, and without a need for manual heuristics. Any data that is collected or monitored of a user can be performed based on an opt-in or opt-out basis, where the user can provide permission.

The terminology used herein is for the purpose of describing particular embodiments only and is not intended to be limiting of the invention. As used herein, the singular forms “a”, “an” and “the” are intended to include the plural forms as well, unless the context clearly indicates otherwise. As used herein, the term “or” is an inclusive operator and can mean “and/or”, unless the context explicitly or clearly indicates otherwise. It will be further understood that the terms “comprise”, “comprises”, “comprising”, “include”, “includes”, “including”, and/or “having.” when used herein, can specify the presence of stated features, integers, steps, operations, elements, and/or components, but do not preclude the presence or addition of one or more other features, integers, steps, operations, elements, components, and/or groups thereof. As used herein, the phrase “in an embodiment” does not necessarily refer to the same embodiment, although it may. As used herein, the phrase “in one embodiment” does not necessarily refer to the same embodiment, although it may. As used herein, the phrase “in another embodiment” does not necessarily refer to a different embodiment, although it may. Further, embodiments and/or components of embodiments can be freely combined with each other unless they are mutually exclusive.

The corresponding structures, materials, acts, and equivalents of all means or step plus function elements, if any, in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A system comprising:
at least one processor;
at least one memory device coupled to the at least one processor,
the at least one processor configured to at least:
determine a project intent;
identify programming requirements needed to fulfill the project intent;
reduce the programming requirements into lower dimensions;
cluster the reduced programming requirements into clusters;
identify a common theme in each of the clusters;
select from at least one of the clusters having a common theme corresponding to the programming requirements, feasible pairs of developers; and
identify at least one optimal pair of developers among the feasible pairs using an optimization algorithm that optimizes the project intent.

2. The system of claim 1, wherein the processor is further configured to recommend the at least one optimal pair of developers.

3. The system of claim 1, wherein the processor is further configured to receive a feedback associated with the identified at least one optimal pair of developers.

4. The system of claim 3, wherein the processor is further configured to repeat the reducing, clustering, identifying, selecting and identifying, until the at least one optimal pair of developers is indicated as acceptable.

5. The system of claim 1, wherein the processor is further configured to recommend to a new requestor a prior identified optimal pair of developers based on determining cosine similarity of the programming requirements between the new requestor and a prior requestor.

6. The system of claim 1, wherein the processor is configured to reduce the programming requirements into lower dimensions using at least one of: principal component analysis (PCA) and t-stochastic neighbourhood embedding (T-SNE).

7. The system of claim 1, wherein the processor is configured to cluster the reduced programming requirements using at least one of: K-clustering and Gaussian mixture model clustering.

8. A computer-implemented method comprising:
determining a project intent;
identifying programming requirements needed to fulfill the project intent;
reducing the programming requirements into lower dimensions;
clustering the reduced programming requirements into clusters;
identifying a common theme in each of the clusters;
selecting from at least one of the clusters having a common theme corresponding to the programming requirements, feasible pairs of developers; and
identifying at least one optimal pair of developers among the feasible pairs using an optimization algorithm that optimizes the project intent.

9. The method of claim 8, further including recommending the at least one optimal pair of developers.

10. The method of claim 8, further including receiving a feedback associated with the identified at least one optimal pair of developers.

11. The method of claim 10, further including repeating the reducing, clustering, identifying, selecting and identifying, until the at least one optimal pair of developers is indicated as acceptable.

12. The method of claim 8, further including recommending to a new requestor a prior identified optimal pair of developers based on determining cosine similarity of the programming requirements between the new requestor and a prior requestor.

13. The method of claim 8, wherein the reducing the programming requirements into lower dimensions includes using at least one of: principal component analysis (PCA) and t-stochastic neighbourhood embedding (T-SNE).

14. The method of claim 8, wherein the clustering the reduced programming requirements includes using at least one of: K-clustering and Gaussian mixture model clustering.

15. A computer program product comprising a computer readable storage medium having program instructions embodied therewith, the program instructions readable by a device to cause the device to:
determine a project intent;
identify programming requirements needed to fulfill the project intent;
reduce the programming requirements into lower dimensions;
cluster the reduced programming requirements into clusters;
identify a common theme in each of the clusters;
select from at least one of the clusters having a common theme corresponding to the programming requirements, feasible pairs of developers; and
identify at least one optimal pair of developers among the feasible pairs using an optimization algorithm that optimizes the project intent.

16. The computer program product of claim 15, wherein the processor is further configured to recommend the at least one optimal pair of developers.

17. The computer program product of claim 15, wherein the processor is further configured to receive a feedback associated with the identified at least one optimal pair of developers.

18. The computer program product of claim 17, wherein the processor is further configured to repeat the reducing, clustering, identifying, selecting and identifying, until the at least one optimal pair of developers is indicated as acceptable.

19. The computer program product of claim 15, wherein the processor is further configured to recommend to a new requestor a prior identified optimal pair of developers based on determining cosine similarity of the programming requirements between the new requestor and a prior requestor.

20. The computer program product of claim 15, wherein the processor is configured to reduce the programming requirements into lower dimensions using at least one of: principal component analysis (PCA) and t-stochastic neighbourhood embedding (T-SNE).
